(19) United States
(12) Patent Application Publication
(10) Pub. No.: US 2007/0079068 A1
(43) Pub. Date: Apr. 5, 2007

(54) Storing data with different specified levels of data redundancy

(75) Inventor: Dave A. Draggon, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/241,159

(22) Filed: Sep. 30, 2005

(51) Int. Cl. G06F 12/16

(52) U.S. Cl. 711/114

(57) ABSTRACT

Methods of storing data with different specified levels of data redundancy are disclosed. In one aspect, a method may include receiving sets of data to be stored on a set of storage devices and information that specifies different levels of data redundancy for the sets of data. Then, the sets of data may be stored on the set of storage devices with different levels of data redundancy based, at least in part, on the information. Apparatus, software, and systems are also disclosed.

### BACKGROUND

1. Field

Embodiments of the invention relate to the field of data storage. In particular, embodiments of the invention relate to storing digital data with different specified levels of data redundancy.

2. Background Information

RAID (Redundant Array of Independent (or Inexpensive) Disks) based storage systems are known in the arts. In a RAID storage system, two or more disk drives may be used in combination to promote data reliability or fault tolerance.

Various levels of RAID use different mechanisms to promote data reliability or fault tolerance. Some levels, such as level 1, level 01, and level 10, may mirror replicate sets of data across multiple storage disk arrays to provide data redundancy. Other levels, such as level 3, level 5, and level 6, may store parity information along with the data to provide data redundancy. Still other levels, such as level 2, may store error correction code along with the data that is stored to provide data redundancy.

Traditional RAID-based storage systems tend to apply such data redundancy mechanisms for all of the data that is stored regardless of the importance or other attributes of the data. This may have drawbacks particularly when storage space is limited or costly.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of a storage architecture in which one or more embodiments of the invention may be implemented.

FIG. 2 is a block diagram of a RAID controller to store sets of data having different corresponding specified levels of data redundancy on different ones of a set of different conventional RAID level storage volumes, according to one or more embodiments of the invention.

FIG. 3 is a block diagram of a RAID controller to store sets of data having different corresponding specified levels of data redundancy on a common hybrid RAID storage volume, according to one or more embodiments of the invention.

FIG. 4 conceptually shows how a RAID controller may store a stream of data that includes information specifying different levels of data redundancy on a common hybrid RAID storage volume, according to one or more embodiments of the invention.

FIG. 5 is a block diagram of a RAID controller to store sets of data on a RAID volume with four different levels of data redundancy based on four different specified levels of data redundancy, according to one or more embodiments of the invention.

FIG. 6 is a block diagram showing a storage architecture, according to one or more embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

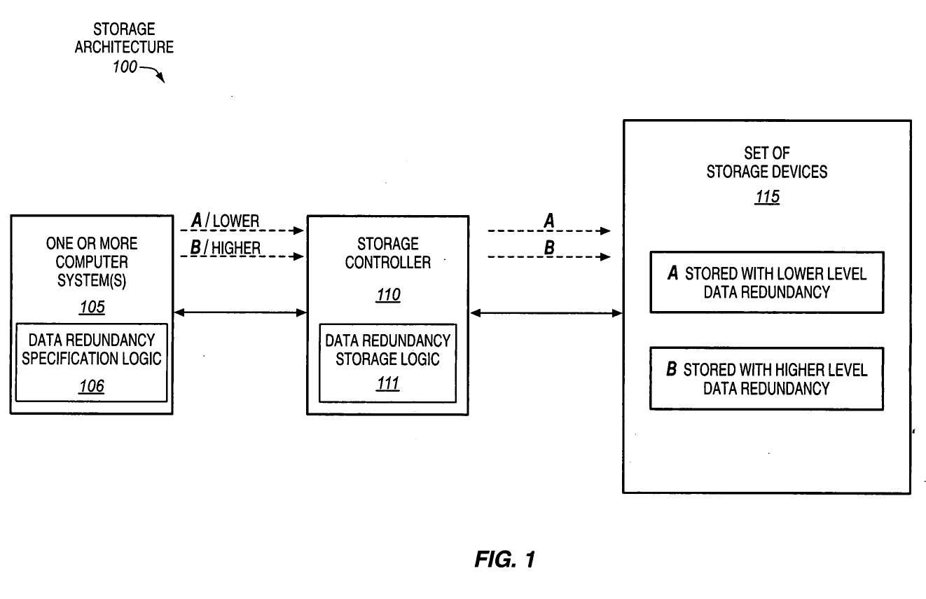

FIG. 1 is a block diagram of a storage architecture 100 in which one or more embodiments of the invention may be implemented. The storage architecture includes one or more computer systems 105, a storage controller 110, such as, for example, a RAID (Redundant Array of Independent (or Inexpensive) Disks) controller, and a set of storage devices 115, such as, for example, a set of RAIDs or other storage disk arrays.

The one or more computer systems are bi-directionally coupled with, or otherwise in communication with the set of storage devices via the intervening storage controller. In the description and claims, the terms “coupled” and “connected,” along with their derivatives, may be used. It should be understood that these terms are not intended as synonyms for each other. Rather, in particular embodiments, “connected” may be used to indicate that two or more components are in direct physical or electrical contact with each other. “Coupled” may mean that two or more components are in direct physical or electrical contact. However, “coupled” may also mean that two or more components are not in direct contact with each other, but yet still co-operate or interact with each other. For example, two or more components may be coupled with one another via one or more intervening components. In addition, two or more components may be in communication with one another if they exchange data or information, regardless of whether they are in direct contact or not. For example, as shown in the illustrated embodiment, the one or more computer systems may be coupled to write data to, and read data from, the storage set of devices via the intervening storage controller.

The computer systems may provide sets of data to be stored on the storage devices to the storage controller. The computer systems may also provide corresponding information that specifies different degrees or levels of fault tolerance or data redundancy for the different sets of data to the storage controller. For example, as shown in the illustrated embodiment, the computer systems may provide a first set of data (labeled “A”), a second set of data (labeled “B”), information specifying that the first set of data (A) is to be stored with a first level of data redundancy (labeled “lower”), and information specifying that the second set of data (B) is to be stored with a second level of data redundancy (labeled “higher”). As used herein, the terms “lower”, “higher”, “low”, “medium”, “high”, “higher”, and the like, are relative terms, and do not refer to any particular absolute level of data redundancy. The information need not specify any particular type or amount of data redundancy but rather may just specify different levels of data redundancy. For example, the number “1” may specify a different level than the number “2”, the number “3” may specify a different level than the number 2, and so on.

The different levels of data redundancy may be specified according to different criteria. In one or more embodiments of the invention, the different levels of data redundancy may be specified based on perceived data importance. For example, a relatively higher level of data redundancy may be used for relatively more important data and a relatively lower level of data redundancy may be used for relatively less important data. According to one possible rational, less perishable data, such as, for example, software applications, may be relatively more important than more perishable data, such as, for example, a browser history listing websites that have been visited. According to another possible rational, data that is difficult or time consuming to regenerate may be relatively more important than data which is easy or quick to regenerate. According to yet another possible rational, data that is expensive, such as purchased data, may be relatively more important than data that is inexpensive or free. These are just a few illustrative examples. Additionally, other criteria besides just data importance may also optionally be used to specify different levels of data redundancy. Other suitable criteria include, but are not limited to, user preference, company policy, and the like. The scope of the invention is not limited to any known criteria.

The different levels of data redundancy may be specified by users, applications, or partly by users and partly by applications. As shown, the one or more computer systems may include data redundancy specification logic 106 to specify different levels of data redundancy. In one aspect, a user may manually specify a level of data redundancy. For example, while saving a file generated using a word processor application, a user may select or otherwise level a degree of data redundancy, such as, for example, via a graphical user interface. This is just one illustrative example. In another aspect, an application may be configured to autonomously specify a level of data redundancy. For example, an Internet browser application may be configured to specify a relatively higher level of data redundancy for certain data, such as, for example, less perishable data like websites added to a users list of favorite websites, and to specify a relatively lower level of data redundancy for other data, such as, for example, more perishable data like a history of websites visited. In one or more embodiments of the invention, a user configuration interface may allow a user to specify different levels of data redundancy for different types of data generated by or otherwise associated with an application. This is just one illustrative example. Other examples will be apparent to those skilled in the art and having the benefit of the present disclosure.

Referring again to FIG. 1, the storage controller may receive the different sets of data (for example A and B) and the information that specifies the different levels of data redundancy for the different sets of data (for example the lower level for A and the higher level for B) from the one or more computer systems. As shown, the storage controller may include data redundancy storage logic 111 to cause the different sets of data to be stored on the set of storage devices with the different levels of data redundancy based on the received information. For example, as shown, the first set of data (A) may be stored on the set of storage devices with a lower level of data redundancy, and the second set of data (B) may be stored on the set of storage devices with a higher level of data redundancy. [In one or more embodiments of the invention, the data redundancy storage logic may include hardware, such as, for example, a circuit, portion of a chip, or chip. As another option, in one or more embodiments of the invention, the data redundancy storage logic may include software, such as, for example, code of the operating system, or another software application. As yet another option, in one or more embodiments of the invention, the data redundancy storage logic may include a combination of hardware and software, such as, for example, hardware assisted RAID software.

In this way, as shown in the illustrated embodiment, different sets of data may be stored with different levels of data redundancy based, at least in part, on differently specified levels of data redundancy. That is, rather than blindly storing all of the data with the same level of data redundancy, regardless of the importance or other attributes of the data, the data may instead be intelligently stored with varying levels of data redundancy. In this way, data redundancy, which typically uses extra storage capacity, may be selectively applied or rationed for certain data, such as more important data. This may also potentially allow more total data to be stored on a limited amount of storage capacity.

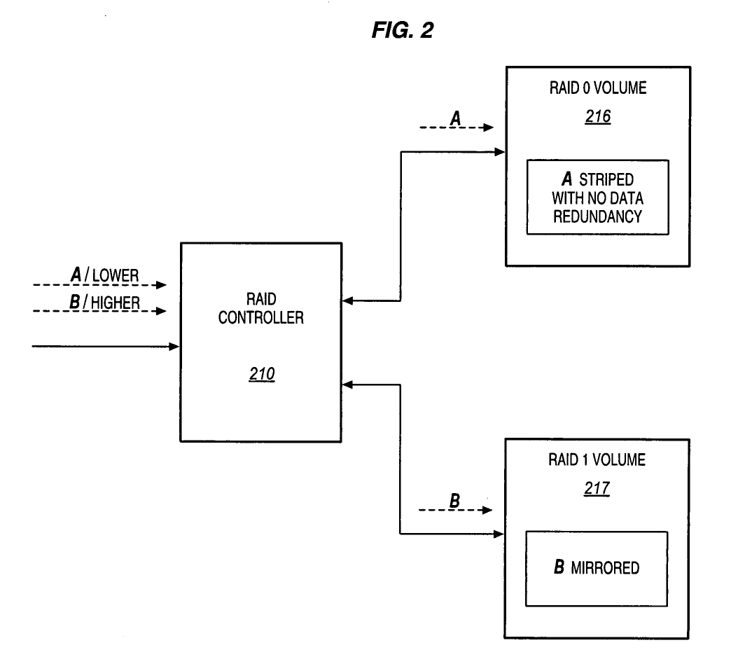

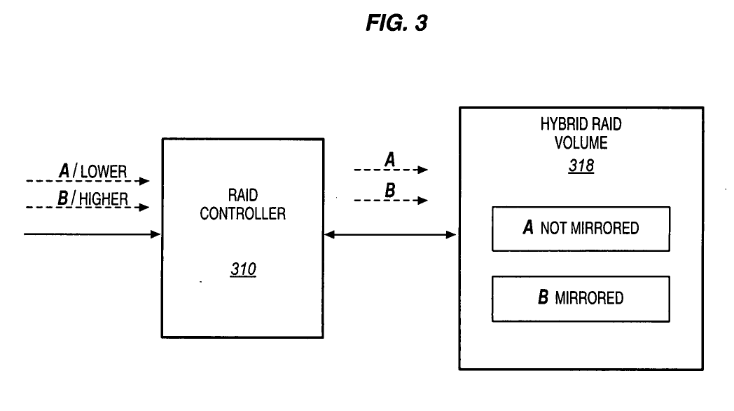

Different ways of storing sets of data on a set of storage devices based on corresponding specified different levels of data redundancy are contemplated. An approach based on different conventional RAID levels is shown in FIG. 2. Several other approaches based on hybrid RAID levels are shown in FIGS. 3 through 5. Still other approaches will be apparent to those skilled in the art and having the benefit of the present disclosure.

FIG. 2 is a block diagram of a RAID controller 210 to store sets of data having different corresponding specified levels of data redundancy on a set of different conventional RAID level storage volumes 216, 217, according to one or more embodiments of the invention. In one aspect, each of the RAID volumes may have different storage devices. In another aspect, storage devices may be shared among RAID volumes.

As shown, the plurality of different conventional RAID level storage volumes may optionally include a RAID-0 storage volume 216, and a RAID-1 storage volume 217, although the scope of the invention is not limited in this respect. Representatively, the RAID-0 storage volume may include a set of first and second storage disk arrays, and the RAID-1 storage volume may include another different set of first and second storage disk arrays, although the scope of the invention is not so limited.

Conventional RAID-0 may provide a striped storage disk array without fault tolerance. For example, RAID-0 may provide data striping in which blocks of each file or other set of data are spread across multiple storage disk arrays without providing data redundancy or fault tolerance.

Conventional RAID-1 may provide mirroring. For example, replicate or identical copies of sets of data may be stored on multiple storage disk arrays. RAID-1 generally provides a fairly high level of data redundancy.

Further background information on RAID-0, RAID-1, and other levels of RAID, if desired, is widely available in the literature and on the Internet. One such source is “The RAID book, A Source Book for Raid Technology”, which was published in 1994, by the Raid Advisory Board (ISBN 1879936909).

Referring again to FIG. 2, the RAID controller may receive different sets of data, for example A and B, and corresponding information specifying different levels of data redundancy for each of the sets of data, for example a lower level for A and a higher level for B. The RAID controller may include data redundancy storage logic to select a RAID level storage volume for each set of data based, at least in part, on the corresponding information specifying the level of data redundancy for that particular set of data.

For example, as shown in the illustrated embodiment, the RAID controller may select the RAID-0 storage volume for the first set of data (A), since a lower level of data redundancy was specified for the first set of data. The RAID controller may also select the RAID-1 storage volume for the second set of data (B), since a higher level of data redundancy was specified for the second set of data. As discussed above, RAID-1 provides greater data redundancy than RAID-0.

Based on the selections, the RAID controller may cause the first set of data (A) to be stored on the RAID-0 storage volume. Likewise, the RAID controller may cause the second set of data (B) to be stored on the RAID-1 storage volume. As shown, A may then be stored on the RAID-0 storage volume by striping across multiple storage disk arrays with no data redundancy, and B may be stored on the RAID-1 storage volume by mirroring across two or more storage disk arrays. Accordingly, a subset of data, such as, for example, relatively more important data, may be stored with higher data redundancy for example provided by mirroring, whereas another subset of data may, such as, for example, relatively less important data, may be stored with low or no data redundancy.

It is to be appreciated that this is just one of many possible combinations of conventional RAID level storage volumes. Various other embodiments are contemplated in which the RAID-1 storage volume is replaced by a RAID-2, RAID-3, RAID-4, RAID-5, RAID-6, RAID-7, RAID-0+1, RAID-10, or RAID-50 storage volume. Still other embodiments are contemplated in which the RAID-0 volume is replaced by non-RAID plain data storage without striping or data redundancy. Still further embodiments are contemplated in which the RAID-0 volume is replaced with another RAID level volume offering a lower level of data redundancy than the RAID-1 volume.

More than just two levels of data redundancy may also optionally be used. For example, three, four, or more than four, different levels of data redundancy may optionally be used. As one example, in addition to the RAID-0 storage volume and RAID-1 storage volume, an additional RAID level storage volume, such as, for example, a RAID-5 or RAID-4 storage volume, may optionally be incorporated to provide an intermediate level of data redundancy that is intermediate between the levels of data redundancy provided by the RAID-0 and RAID-1 volumes. Continuing with this example, yet another RAID level storage volume, such as, for example, a RAID-2 storage volume, may optionally be incorporated to provide a level of data redundancy that is intermediate between the RAID-4 or RAID-5 level and the RAID-1 level. Again, these are just a few of many possible configurations. Those skilled in the art and having the benefit of the present disclosure will appreciate that numerous other combinations of conventional RAID level storage volumes are also suitable.

FIG. 3 is a block diagram of a RAID controller 310 to store sets of data having different corresponding specified levels of data redundancy on a common hybrid RAID storage volume 318, according to one or more embodiments of the invention. At least conceptually, the hybrid RAID storage volume may resemble a hybrid, cross, or combination of a RAID-0 storage volume and a RAID-1 storage volume.

As before, the RAID controller may receive different sets of data, such as, for example A and B. The RAID controller may also receive corresponding information specifying a lower level of data redundancy, such as for the first set of data (A), and corresponding information specifying a higher level of data redundancy, such as for the second set of data (B).

The RAID controller may cause the first set of data (A) to be stored on the RAID volume without mirroring, since a lower level of data redundancy was specified for this set of data. The first set of data may optionally be striped similar as in RAID-0. The RAID controller may cause the second set of data (B) to be stored on the RAID volume with mirroring, since a higher level of data redundancy was specified for this set of data. The second set of data may optionally be mirrored similar as in RAID-1. In one aspect, both the first and second sets of data (A and B) may be stored on the same pair or other set of storage disk arrays.

Now, to further illustrate how different sets of data may be stored on a set of storage devices based at least in part on different specified levels of data redundancy, let's consider a detailed working example. This example uses an approach somewhat similar to the approach shown in FIG. 3.

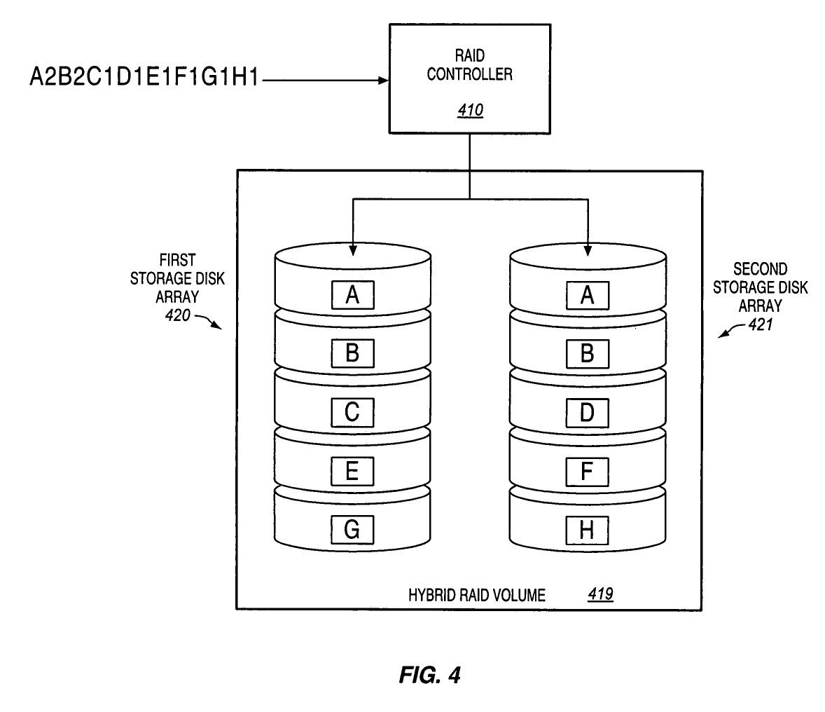

FIG. 4 conceptually shows how a RAID controller 410 may store a stream of data that includes information specifying different levels of data redundancy on a common hybrid RAID storage volume 419, according to one or more embodiments of the invention. The particular illustrated RAID storage volume includes a first storage disk array 420 and a second storage disk array 421, although the scope of the invention is not so limited.

The stream of data is provided to the RAID controller. As shown in the illustrated embodiment, the stream of data may include A2B2C1D1E1F1G1H1. Each letter may represent a different block, byte, or other set of data. The numbers “1” and “2” represent information specifying different levels of data redundancy and are embedded in the data stream. According to one possible convention, each number “1” may specify a first level of data redundancy for a preceding number, and each number “2” may specify a second level of data redundancy for a preceding number. In this particular example, a “1” specifies a lower level of data redundancy than a “2”, although the scope of the invention is not limited in this respect. Accordingly, in this example, A and B each have the same specified higher level of data redundancy, and C, D, E, F, G, and H each have the same specified lower level of data redundancy.

In RAID-1, all of A, B, C, D, E, F, G, and H would generally be mirrored or replicated on the first and second storage disk arrays. Mirroring all of the data may use more storage capacity. In some cases, depending upon the amount of data, it is possible that all of the data may not fit on the RAID storage volume.

In contrast to RAID-1, in accordance with one or more embodiments of the invention, only a subset of the data may be mirrored. For example, as shown, only A and B may be mirrored, since higher levels of data redundancy are specified for A and B. The sets of data C, D, E, F, G, and H, may not be mirrored, since lower levels of data redundancy are specified in the data stream for these sets of data.

By mirroring only a subset of the data based on different specified levels of data redundancy, storage space may be intelligently and selectively rationed. Additionally, more sets of data may potentially be stored on the same physical storage capacity.

Before proceeding, let's briefly discuss several illustrative alternate ways in which data redundancy levels may be specified. As shown, the information specifying the different level of data redundancy may be embedded or interleaved with the different sets of data. The information may either precede or follow the data. Information may be omitted for a given level, such as, for example, a default level, the lowest level, the highest level, or another level. Information other than numbers may specify levels of data redundancy. Words, such as, for example, high, medium, low, etc., may optionally be used. Codes may also optionally be used. The information may also optionally be provided separately from the data, such as, for example, in a separate data stream, file, or data structure. In one aspect, blocks of data having block identifiers may be provided and a separate file or data structure having corresponding pairs of the block identifiers and data redundancy specification information. As another option, the sets of data may include storage objects, such as, for example, in an object store environment, and the one or more computer systems may encapsulate and store the information along with other properties of the objects. Storage objects are known in the arts to represent virtual entities that may group data that is related. An object store may include a group of storage objects. These are just a few illustrative options, and the scope of the invention is not limited to just these options. Still other approaches will be apparent to those skilled in the art and having the benefit of the present disclosure.

Sources of data redundancy other than mirroring are also suitable. For example, the embodiments disclosed above may also optionally be adapted to embodiments in which data redundancy is applied through parity, error correction code, or a combination of parity and error correction code. To further illustrate, another exemplary embodiment will be provided.

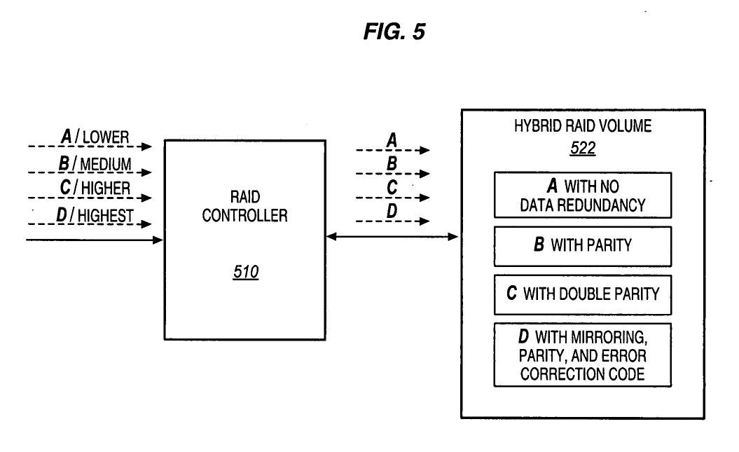

FIG. 5 is a block diagram of a RAID controller 510 to store sets of data on a hybrid RAID volume 522 with four different levels of data redundancy based on four different specified levels of data redundancy, according to one or more embodiments of the invention.

As shown, the RAID controller may receive a first set of data (A), a second set of data (B), a third set of data (C), and a fourth set of data (D). The RAID controller may also receive corresponding information specifying a lower level of data redundancy for the first set of data (A), information specifying a medium level of data redundancy for the second set of data (B), information specifying a higher level of data redundancy for the third set of data (C), and information specifying a highest level of data redundancy for the fourth set of data (D).

The RAID controller may cause the first set of data (A) to be stored on the hybrid RAID volume with a relatively lower level of data redundancy, the second set of data (B) to be stored on the hybrid RAID volume with a medium level of data redundancy, the third set of data (C) to be stored on the hybrid RAID volume with a higher level of data redundancy, and the fourth set of data (D) to be stored on the hybrid RAID volume with a higher level of data redundancy. In particular, in the illustrated embodiment, A may optionally be stored with no data redundancy, B may optionally be stored with data redundancy provided through parity information, C may optionally be stored with data redundancy provided through double parity information, and D may optionally be stored with data redundancy provided through mirroring, parity, and error correction code.

This is just one illustrative example. Other implementations will be apparent to those skilled in the art and having the benefit of the present disclosure.

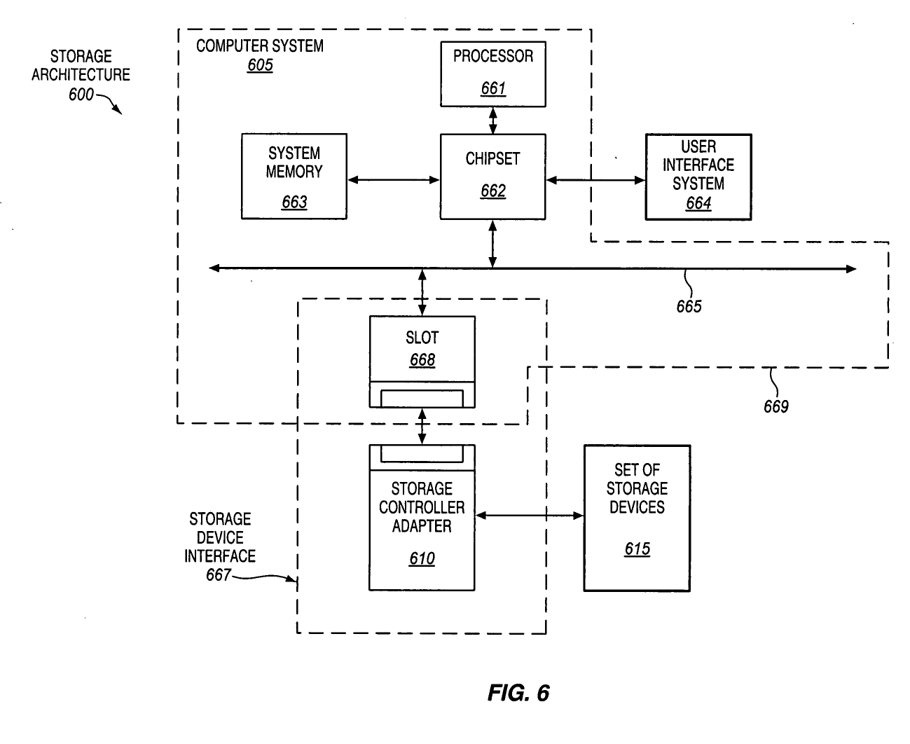

FIG. 6 is a block diagram showing a storage architecture 600, according to one or more embodiments of the invention. The storage architecture includes a computer system 605, a user interface system 664, a set of storage devices 615, and a storage controller adapter 610 to allow the computer system to interface with the storage device.

As used herein, a “computer system” may include an apparatus having hardware and/or software to process data. The computer system may include, but is not limited to, a portable, laptop, desktop, server, or mainframe computer, to name just a few examples. The computer system represents one possible computer system for implementing one or more embodiments of the invention, however other computer systems and variations of the computer system are also possible.

The computer system includes a processor 661 to process information. In one or more embodiments, the processor may include a processor in the Pentium® family of processors, such as, for example, a Pentium® 4 processor. The Pentium® family of processors are commercially available from Intel Corporation, of Santa Clara, Calif. Alternatively, other processors may optionally be used. As one example, a processor having multiple processing cores may be used. As another example, a processor manufactured and/or commercially available from a source other than Intel Corporation may optionally be used. Further, in one or more embodiments, the computer system may include multiple processors.

The processor is coupled with a chipset 662 by an interface. As shown, a system memory 663, the user interface system 664, and one or more input/output (I/O) buses or other interconnects 665, may also each be coupled with, or otherwise in communication with the chipset by respective interfaces.

In one or more embodiments of the invention, the chipset may include one or more integrated circuits or other microelectronic devices, such as, for example, those that are commercially available from Intel Corporation. However, other microelectronic devices may also, or alternatively, be used.

In one or more embodiments of the invention, the chipset may include a first bridge/hub (not shown), such as, for example, a memory control bridge/hub available from Intel Corporation, and a second bridge/hub (not shown), such as, for example, an input/output (I/O) bridge/hub available from Intel Corporation. In one or more other embodiments, at least a portion of the memory control bride/hub, such as, for example, the memory controller, may be in the same chip as the processor. The first bridge/hub may be coupled with the second bridge/hub by a hub interface. However, the scope of the invention is not limited to using such chipsets.

The system memory may be coupled with, or in communication with, the memory control bridge/hub, or otherwise in communication with the chipset. In one or more embodiments of the invention, the system memory may include a main memory, such as, for example, a random access memory (RAM) or other dynamic storage device, to store information including instructions to be executed by the processor. Different types of RAM memory that are included in some, but not all computer systems, include, but are not limited to, static-RAM (SRAM) and dynamic-RAM (DRAM). Other types of RAM that are not necessarily dynamic or need to be refreshed may also optionally be used. In one or more embodiments of the invention, applications having code or instructions to specify different levels of data redundancy for their application data may be stored in main memory, such as, for example, in DRAM.

Additionally, in one or more embodiments of the invention, the system memory may include a read only memory (ROM) to store static information and instructions for the processor, such as, for example, the basic input-output system (BIOS). Different types of memory that are included in some, but not all, computer systems include Flash memory, programmable ROM (PROM), erasable-and-programmable ROM (EPROM), and electrically-erasable-and-programmable ROM (EEPROM).

The user interface system may representatively include devices, such as, for example, a display device, a keyboard, a cursor control device, and combinations thereof, although the scope of the invention is not limited in this respect. For example, some computer systems, such as servers, may optionally employ simplified user interface systems.

The one or more I/O interconnects and the user interface system may be coupled with, or otherwise in communication with, the I/O bridge/hub, or otherwise in communication with the chipset. Suitable I/O interconnects include, but are not limited to, peripheral component interconnect (PCI) family buses, accelerated graphics port (AGP) buses, universal serial bus (USB) buses, low pin count (LPC) buses, other kinds of I/O buses, or combinations thereof. In one particular embodiment of the invention, the one or more I/O interconnects may include a PCI, PCIX (PCI extended), and/or PCI-Express (PCI-E) bus. The chipset and the I/O bridge/hub may accordingly support standard I/O operations on one or more of such I/O interconnects. As shown in the illustrated embodiment, a storage device interface 667 may be coupled with the one or more I/O interconnects. The one or more interconnects may be used to communicate information among components.

The illustrated storage device interface includes a slot or port 668 and the storage controller adapter 610. The adapter may include storage controller or RAID controller logic as disclosed elsewhere herein in order to allow the computer system and the set of storage device to communicate with and/or access one another. In one or more embodiments of the invention, the adapter may include hardware logic. The hardware logic may include integrated circuitry that may reside on a chip, such as, for example, an ASIC chip. In various embodiments of the invention, the hardware logic described herein may be incorporated into devices, such as, for example, RAID controllers, adapters, and the like. In one particular embodiment of the invention, the logic described herein may be included in Intelligent RAID controllers utilizing Intel® I/O processors based on Intel XScale® technology. The Intelligent RAID controller may represent a substantially independent I/O subsystem having the intelligent I/O processor, a battery-backed memory to execute important RAID algorithms, and supported by algorithm acceleration hardware to expedite RAID processing. However, the scope of the invention is not so limited. The logic may also optionally be implemented as software that may be executed by a processor on the adapter or the processor of the computer system.

The adapter may optionally have the form of a card, although this is not required. The slot is coupled with, or otherwise in communication with, the one or more I/O interconnects. The slot and the adapter may be constructed to permit the adapter to be inserted into the slot and electrically coupled with the slot to allow the adapter to be coupled with, or otherwise in communication with, the one or more I/O interconnects. For example, an interface of the slot may include a bus or other interconnect connector that may be electrically and mechanically mated with a mating bus or other interconnect connector that may be included in an expansion slot or interface of the adapter. When the adapter is properly inserted into the slot, the mating connectors may become mechanically and/or electrically coupled with each other. When the connectors are so coupled with each other, the adapter may become electrically coupled with the one or more I/O interconnects and may exchange data with components of the computer system.

The storage device may be coupled with the storage device interface, for example the adapter, via a link. Suitable storage devices include, but are not limited to, hard disks, pluralities of hard disks, storage disk arrays, Just a Bunch Of Disks (JBOD), other sets of hard disks configured other than by RAID, RAIDs, and ones, pluralities, and arrays of other types of storage devices besides hard disks, such as, for example, CD-ROM devices, tape drives, Zip drives, SuperDisk drives, and the like.

Now, as shown in the illustrated embodiment, the processor, system memory, chipset, one or more I/O interconnects, and slot may optionally be included on or otherwise connected to a main circuit board 669, such as, for example, a motherboard or backplane. The motherboard and the components connected thereto are often housed within a primary chassis or housing of the computer system. Components of the user interface system and the set of storage devices may, in one or more embodiments, be outside of the chassis or housing. The slot may represent an opening into the chassis or housing into which the adapter may be inserted.

However, this particular configuration is not required. Numerous alternate configurations are also contemplated. For example, in various alternate embodiments of the invention, portions of the adapter may be integrated onto the motherboard or backplane and provided within the chassis or housing. Many additional modifications are also contemplated. As one representative example, a RAID controller as disclosed herein may be integrated or consolidated with the chipset, such as, for example, an I/O bridge/hub.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

Various operations and methods have been described. Some of the methods have been described in a basic form, but operations may optionally be added to and/or removed from the methods. The operations of the methods may also often optionally be performed in different order. Many modifications and adaptations may be made to the methods and are contemplated.

Certain operations may be performed by hardware components, or may be embodied in machine-executable instructions, that may be used to cause, or at least result in, a circuit programmed with the instructions performing the operations. The circuit may include a general-purpose or special-purpose processor, or logic circuit, to name just a few examples. The operations may also optionally be performed by a combination of hardware and software.

One or more embodiments of the invention may be provided as a program product or other article of manufacture that may include a machine-accessible and/or readable medium having stored thereon one or more instructions and/or data structures. The medium may provide instructions, which, if executed by a machine, may result in and/or cause the machine to perform one or more of the operations or methods disclosed herein. Suitable machines include, but are not limited to, computer systems, HBAs, motherboards, docking stations, network devices, and a wide variety of other devices with one or more processors, to name just a few examples.

The medium may include, a mechanism that provides, for example stores and/or transmits, information in a form that is accessible by the machine. For example, the medium may optionally include recordable and/or non-recordable mediums, such as, for example, floppy diskette, optical storage medium, optical disk, CD-ROM, magnetic disk, magneto-optical disk, read only memory (ROM), programmable ROM (PROM), erasable-and-programmable ROM (EPROM), electrically-erasable-and-programmable ROM (EEPROM), random access memory (RAM), static-RAM (SRAM), dynamic-RAM (DRAM), Flash memory, and combinations thereof.

A medium may also optionally include an electrical, optical, acoustical, radiofrequency, or other form of propagated signal, such as carrier waves, infrared signals, digital signals, for example. One or more embodiments of the invention may be downloaded as a computer program product, wherein the program may be transferred from one machine to another machine by way of data signals embodied in a carrier wave or other propagation signal or medium via a communication link (e.g., a modem or network connection).

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Such recitations do not necessarily refer to the same embodiment. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Accordingly, while the invention has been thoroughly described in terms of several embodiments, those skilled in the art will recognize that the invention is not limited to the particular embodiments described, but may be practiced with modification and alteration within the spirit and scope of the appended claims. The description is thus to be regarded as illustrative instead of limiting.

What is claimed is:

1. A method comprising:
receiving a first set of data and information that specifies a first level of data redundancy for the first set of data;
receiving a second set of data and information that specifies a second level of data redundancy for the second set of data, wherein the second level of data redundancy is greater than the first level of data redundancy;
storing the first and second sets of data on a set of storage disk arrays, wherein the second set of data is stored on the set of storage disk arrays with a greater level of data redundancy than the first set of data.

2. The method of claim 1, wherein said storing comprises storing the first and second sets of data on at least one RAID (Redundant Array of Independent (or Inexpensive) Disks).

3. The method of claim 1, wherein the second set of data is mirrored, and wherein the first set of data is not mirrored.

4. The method of claim 1, wherein parity information for the second set of data is stored, and wherein parity information for the first set of data is not stored.

5. The method of claim 1, wherein error correction code for the second set of data is stored, and wherein error correction code for the first set of data is not stored.

6. The method of claim 1, wherein said receiving the first set of data and the information that specifies the first level of data redundancy for the first set of data comprises receiving a storage object having the information as a property of the storage object.

7. An article of manufacture comprising:
a machine-accessible medium to provide instructions that if executed result in a machine performing operations including,
receiving sets of data to be stored on a set of storage devices and information that specifies different levels of data redundancy for the sets of data, and
causing the sets of data to be stored on the set of storage devices with different levels of data redundancy based at least in part on the information.

8. The article of manufacture of claim 7, wherein the instructions that if executed result in the machine causing the sets of data to be stored further comprise instructions that if executed result in the machine performing operations including,
causing the sets of data to be stored on at least one RAID (Redundant Array of Independent (or Inexpensive) Disks).

9. The article of manufacture of claim 7, wherein the instructions that if executed result in the machine causing the sets of data to be stored further comprise instructions that if executed result in the machine performing operations including,
causing a plurality of copies of a first set of data having corresponding information that specifies a higher level of data redundancy to be stored, and
causing a single copy of a second set of data having corresponding information that specifies a lower level of data redundancy to be stored.

10. The article of manufacture of claim 7, wherein the instructions that if executed result in the machine causing the sets of data to be stored further comprise instructions that if executed result in the machine performing operations including,
causing parity information for a first set of data having corresponding information that specifies a higher level of data redundancy to be stored; and
causing at least less parity information for a second set of data having corresponding information that specifies a lower level of data redundancy to be stored.

11. The article of manufacture of claim 7, wherein the instructions that if executed result in the machine causing the sets of data to be stored further comprise instructions that if executed result in the machine performing operations including,
causing error correction code for a first set of data having corresponding information that specifies a higher level of data redundancy to be stored; and
causing at least less error correction code for a second set of data having corresponding information that specifies a lower level of data redundancy to be stored.

12. The article of manufacture of claim 7, wherein the instructions that if executed result in the machine receiving the sets of data and the information further comprise instructions that if executed result in the machine performing operations including,
receiving a storage object having a set of data and information that specifies a level of data redundancy for the set of data as a property of the software object.

13. An article of manufacture comprising:
a machine-accessible medium to provide instructions that if executed result in a machine performing operations including,
specifying different levels of data redundancy for different sets of data to be stored, and
communicating the sets of data and the specified levels of data redundancy to a Redundant Array of Independent (or Inexpensive) Disks (RAID) controller.

14. The article of manufacture of claim 13, wherein the machine-accessible medium further provides instructions that if executed result in the machine performing operations including,
specifying a level of data redundancy as a property of a storage object having one of the different sets of data.

15. The article of manufacture of claim 13, wherein the machine-accessible medium further provides instructions that if executed result in the machine performing operations including,
specifying the different levels of data redundancy for the different sets of data based at least in part on perceived importance of the different sets of data.

16. The article of manufacture of claim 13, wherein the machine-accessible medium further provides instructions that if executed result in the machine performing operations including,
providing a user interface to accept user input regarding a level of data redundancy for a set of data.

17. A system comprising:
one or more buses;
a processor coupled with the one or more buses;
a dynamic random access memory (DRAM) coupled with the one or more buses;
logic to cause sets of data to be stored on a set of storage devices with different levels of data redundancy based at least in part on information that specifies different levels of data redundancy for the sets of data.

18. The system of claim 17, wherein the logic further comprises logic to:
cause a plurality of copies of a first set of data having corresponding information that specifies a higher level of data redundancy to be stored; and
cause a single copy of a second set of data having corresponding information that specifies a lower level of data redundancy to be stored.

19. The system of claim 17, wherein the logic further comprises logic to:
causing parity information for a first set of data having corresponding information that specifies a higher level of data redundancy to be stored; and
causing at least less parity information for a second set of data having corresponding information that specifies a lower level of data redundancy to be stored.

20. The system of claim 17, wherein the logic further comprises logic to look to a property of a software object to determine a specified level of data redundancy for a set of data of the software object.
